(19) United States
(12) Patent Application Publication
(10) Pub. No.: US 2026/0307276 A1
(43) Pub. Date: Oct. 8, 2026

(54) GRIPPER FOR AN OPHTHALMIC LENS AND PROCESS FOR TRANSPORTING AN OPHTHALMIC LENS

(71) Applicant: Alcon Inc., Fribourg (CH)

(72) Inventors: Felix Brinckmann, Roßdorf (DE); Ingo Hartl, Dieburg (DE); Stefan Schulte, Bad König (DE); Nils Schweizer, Bad König (DE); Johannes Vogel, Eschau (DE); Jens Wolfstädter, Kleinwallstadt (DE)

(21) Appl. No.: 19/636,404

(22) Filed: Apr. 1, 2026

Related U.S. Application Data
(60) Provisional application No. 63/782,807, filed on Apr. 3, 2025.

(51) Int. Cl. B25J 15/06; B25J 13/08; B65B 25/00; B65B 35/18

(52) U.S. Cl. CPC B25J 15/0666; B25J 13/085; B65B 25/008; B65B 35/18

(57) ABSTRACT

The invention relates to a gripper for an ophthalmic lens and comprises a gripper head with a convex bearing surface. Convex bearing surface comprises a plurality of suction openings to make the ophthalmic lens adhere to bearing surface. Bearing surface further comprises a guide opening. An ejector rod is movably arranged in guide opening for mechanically displacing the ophthalmic lens away from the convex bearing surface. Ejector rod comprises a detector channel extending through ejector rod and being fluidically connected with a detector opening at the distal end of ejector rod for applying a test-vacuum through detector opening to detect whether or not a said ophthalmic lens adheres to the convex bearing surface when ejector rod is arranged in the rest position.

### FIELD OF THE INVENTION

The invention relates to a gripper for an ophthalmic lens and to a process for transporting an ophthalmic lens.

### BACKGROUND

In the automated production of ophthalmic lenses in general, but especially in the production of large batches of ophthalmic lenses, as is the case for example with disposable ophthalmic lenses, it is necessary at certain stations in the production process to be able to manipulate the ophthalmic lenses safely, quickly and efficiently. An example of such manipulation of an ophthalmic lens is when the ophthalmic lens is removed from a test cell in which said ophthalmic lens has been placed in a liquid, for example in water, in order to be inspected (e.g. by capturing an image of the ophthalmic lens with a camera and by subsequent image processing).

To remove the inspected ophthalmic lens from the test cell (e.g. an inspection cuvette), known devices called grippers are typically used. Grippers are also used at other stations in such automated production processes. The ophthalmic lens is gripped with the aid of the gripper, and in the example described above the gripper together with the gripped ophthalmic lens is removed from the test cell. Thereafter, the gripper together with the ophthalmic lens adhered thereto is moved, for example, to a receptacle (e.g. a packaging shell comprising a bowl) which can be part of the final primary package for the ophthalmic lens and into which a storage solution (e.g. saline) has been or will be dispensed. The ophthalmic lens is then released from the gripper and placed in the bowl of the packaging shell. At the time of placing the ophthalmic lens in the bowl, either a small amount of storage solution (e.g. saline) or no storage solution may be present in the bowl. Accordingly, after placement of the ophthalmic lens in the bowl either the rest of the storage solution (the total amount of storage solution minus the small amount that has been dispensed into the receptacle prior to placement of the ophthalmic lens) or the total amount of storage solution is dispensed into the bowl. Thereafter, the packaging shell is covered with a foil which is welded or sealed to the packaging shell, and after subsequent autoclaving the final primary package (packaging shell containing the ophthalmic lens stored in the storage solution with the cover foil sealed thereto) can be distributed.

In the above-described removal of an ophthalmic lens from a test cell or other environment from which it is removed, and the subsequent dispensing of the ophthalmic lens into the bowl of the packaging shell in which saline is (or will be) present, care must be taken to ensure that only a very small amount of water, preferably no water at all, is entrained with the ophthalmic lens, otherwise the saline may become diluted. This is a problem that is not easy to solve at all, because the ophthalmic lens contained in the above-mentioned test cell has to be sucked from “under water” (with the result that water is necessarily also sucked out of the test cell together with the ophthalmic lens), has to be transported to the packaging shell, and finally must be placed in the bowl of the packaging shell. For the latter purpose, the ophthalmic lens must be released again from the gripper. In addition, the ophthalmic lens must be securely gripped by the gripper (even “under water”), and in the case of small bowls the ophthalmic lens must be reliably placed in the bowl at the location of the bowl so that the ophthalmic lens cannot get damaged later during the welding or sealing of the cover foil.

For this reason, after gripping the ophthalmic lens a check is performed whether the ophthalmic lens has been successfully gripped by the gripper and properly adheres to the gripper. For this purpose, a test-vacuum may be applied to the ophthalmic lens through the gripper. In case the test-vacuum rises above a certain threshold value, it is determined that the ophthalmic lens does not adhere to the gripper at all or at least does not properly adhere to the gripper. In such case, the ophthalmic lens may not be placed in the bowl of the packaging shell. In case it is determined that the ophthalmic lens properly adheres to the gripper, the gripper together with the ophthalmic lens is moved to the packaging shell and the ophthalmic lens is placed in the bowl.

A gripper capable of checking whether an ophthalmic lens properly adheres to the gripper is known from US 2020/0130955 A1. In this document, the gripper comprises a detection vacuum tube being arranged in an interior of the gripper. The detection vacuum tube leads to a separate detection through-opening in a bearing surface of the gripper. The detection vacuum tube has a distal end which is arranged in the detection through-opening in a fluid-tight manner. This allows to apply a detection vacuum through the detection vacuum tube to the detection through-opening. The detection through-opening is arranged at the center of the bearing surface of the gripper and thus allows for the proper detection of the ophthalmic lens adhering to the gripper even in cases in which the ophthalmic lens adheres to the bearing surface in a slightly decentered manner. Removal of the ophthalmic lens from the bearing surface of the gripper is accomplished by discontinuing the underpressure (suction) that makes the lens adhere to the bearing surface of the gripper, and by applying overpressure through the suction openings in the bearing surface instead. Due to the overpressure applied through the suction openings the ophthalmic lens is blown off the bearing surface. However, care must be taken in controlling the overpressure to ensure that the air flow through the suction openings in the bearing surface of the gripper (caused by the overpressure) does not have an adverse effect on the saline that may already be contained in the bowl of the packaging shell or on the ophthalmic lens after placement in the receptacle. For example, if too high an overpressure is applied, saline which may have been dispensed into the bowl of the packaging shell prior to placing the ophthalmic lens in the bowl may at least partially be blown out of the bowl. This may lead, for example, to problems in the subsequent welding or sealing of the cover foil to the packaging shell, since droplets blown out of the bowl may deposit in the area where the cover foil is to be sealed to the packaging shell, so that welding or sealing of the foil to the packaging shell may be performed incompletely. In an even worse case, the ophthalmic lens itself may be blown out of the bowl so that no ophthalmic lens is contained in the bowl anymore. On the other hand, in case too low an overpressure is applied through the suction openings in the bearing surface, in some instances the ophthalmic lens may not be completely released from the gripper but instead may continue to at least partially adhere to the bearing surface of the gripper. In both cases, i.e. when the ophthalmic lens has been blown out of the bowl or has not been completely released from the bearing surface of the gripper (and is not placed in the bowl, accordingly), no ophthalmic lens is contained in the bowl so that the welded or sealed primary package does not contain an ophthalmic lens. Even though such non-placements are detected in a subsequent lens presence check performed prior to sealing or welding the cover foil to the primary packaging shell, such package and any additional packages connected to such package to form a strip of packages (for example when being sealed by a common foil extending over a plurality of packages) must be sorted out and discarded and cannot be distributed. In addition, when the ophthalmic lens has not successfully been released from the bearing surface and the gripper subsequently returns to its starting position to grip (suck) another ophthalmic lens, it may be unable to grip the next ophthalmic lens since the previously gripped ophthalmic lens still adheres to the bearing surface.

A gripper that is capable of releasing an ophthalmic lens from the bearing surface but that does not have the above-mentioned problem of applying too high an overpressure or too low an overpressure for releasing the lens from the gripper is known from WO 2015/036431 A1. This gripper comprises an ejector for mechanically displacing the ophthalmic lens away from a bearing surface. The ejector comprises a plurality of ejector pins. The ejector together with its ejector pins is movable from a rest position in which the ejector pins do not interfere with the bearing surface, to an ejection position in which the ejector pins axially protrude beyond the bearing surface. By mechanically displacing the ophthalmic lens away from the bearing surface of the gripper, the ophthalmic lens is released from the bearing surface and is placed in the bowl of the packaging shell. And even though this placement of the ophthalmic lens in the bowl works without the presence of a small amount of storage liquid (e.g. saline) in the bowl, such presence of a small amount of storage liquid (e.g. saline) may further enhance the security of the placement of the ophthalmic lens in the bowl, since adhesive forces between the front surface of the ophthalmic lens and the storage liquid at the time the ophthalmic lens comes into contact with the storage liquid are stronger than adhesive forces between the rear surface of the contact lens and the ejector pins of the ejector. In any event, there is no need for applying any overpressure at all in order to release the ophthalmic lens from the bearing surface of the gripper. However, in case of a sensitive ophthalmic lens there is a risk that the ophthalmic lens may become mechanically damaged by the ejector pins, as the ejector pins mechanically push the ophthalmic lens away from the bearing surface. Moreover, in the ejection position, there is still an adhesive force between the ejector pins and the rear surface of the ophthalmic lens, so that in a few instances the ophthalmic lens may not be placed in the bowl of the packaging shell, but may continue to adhere to the ejector pins.

In addition, this gripper comprises a separate detection through-opening which is arranged off-center in the bearing surface of the gripper. A separate detection vacuum can be applied to this detection through-opening (in a manner similar to how it has been described above for the gripper with the centrally arranged detection through-opening) to determine whether or not the ophthalmic lens adheres to the bearing surface of the gripper. However, in case the ophthalmic lens does not centrally adhere to the bearing surface of the gripper it may occur that upon the application of the detection vacuum to the detection through-opening the ophthalmic lens may not or at least may not sufficiently cover the detection through-opening which-due to being arranged off-center-is arranged a radial distance away from the center of the bearing surface. For example, toric ophthalmic lenses with prism ballast may not be exactly arranged at the center of the concave bottom of the inspection cuvette as they may not come to lie exactly at the center of the concave bottom of the cuvette when settling down in the water contained in the cuvette due to their inhomogeneous mass distribution. In such case, even though such toric ophthalmic lens may have been gripped and may adhere to the bearing surface off-center, the result of the detection may be “no ophthalmic lens adhering to the bearing surface” although actually an ophthalmic lens has been gripped and adheres to the bearing surface (but does not cover the detection through-opening). As a further consequence of the ophthalmic lens adhering to the bearing surface off-center, at the destination location (primary packaging station) the ophthalmic lens may not be accurately placed in the bowl of the packaging shell, so that the ophthalmic lens—or part of it—may get sealed between the foil and the plane upper surface of the packaging shell.

Also, in case an ophthalmic lens inadvertently is not released from the surface of the gripper at the primary packaging station and continues to adhere to the bearing surface of the gripper, another detection that may be performed with the aid of the detection vacuum applied to the detection through-opening in the bearing surface of the gripper on the gripper's way back to the inspection cuvette may result in the determination that no ophthalmic lens adheres to the bearing surface even though the ophthalmic lens inadvertently continues to adhere to the bearing surface. Accordingly, at the time the gripper arrives at the inspection cuvette again to grip the next ophthalmic lens, the gripper may grip the next ophthalmic lens from the inspection cuvette as supposedly there is no ophthalmic lens adhering to the bearing surface. This may lead to occurrences where—after gripping the next ophthalmic lens—two ophthalmic lenses may simultaneously adhere to the bearing surface of the gripper. In such instance, the detection vacuum applied to the detection through-hole in the bearing surface of the gripper only indicates that there is an ophthalmic lens adhering to the bearing surface of the gripper but is unable to detect that actually two ophthalmic lenses are adhering to the bearing surface. In such a scenario, the two ophthalmic lenses adhering to the bearing surface may be released from the bearing surface at the primary packaging station and may be placed in the bowl of the packaging shell. However, apart from the fact that only one single ophthalmic lens is to be placed in the bowl of each individual packaging shell, the ophthalmic lenses may not be accurately placed in the bowl but rather may be placed at locations where the ophthalmic lenses—or part of them—may get sealed between the foil and the upper surface of the packaging shell. Such scenarios are to be avoided since they reduce the yield of the production process.

To summarize, it can be said that both prior art grippers described above are open to improvements. In particular, there exists a need to make sure an ophthalmic lens gripped by a gripper at a starting location is safely adhered to, detected and subsequently released from the bearing surface of the gripper at a destination location. Any adverse effects caused by excessive or insufficient overpressure applied through the suction through-openings in the gripper's bearing surface to release the ophthalmic lens from the gripper must be avoided. Moreover, incorrect determinations as to whether or not an ophthalmic lens is adhered to the gripper should be avoided.

### SUMMARY OF THE INVENTION

The present invention suggests a gripper as it is specified by the features of the independent claims directed to a gripper and to a process for transporting an ophthalmic lens. Advantageous embodiments of the gripper and of the process are the subject of the corresponding dependent claims.

More specifically, the present invention suggests a gripper for an ophthalmic lens, in particular a contact lens such as a soft contact lens. The gripper comprises:
a gripper head heaving a convex bearing surface for the ophthalmic lens to adhere thereto, wherein the convex bearing surface comprises a plurality of suction openings through which suction supplied to an interior of the gripper can be applied to the ophthalmic lens in order to make the ophthalmic lens adhere to the convex bearing surface, wherein the convex bearing surface further comprises a guide opening;
an ejector rod movably arranged in the guide opening, for mechanically displacing the ophthalmic lens away from the convex bearing surface;
an actuator connected to the ejector rod, for moving the ejector rod from a rest position in which a distal end of the ejector rod is arranged in the guide opening but does not protrude distally beyond the convex bearing surface, to an ejection position in which the distal end of the ejector rod protrudes beyond the convex bearing surface.

Both in the rest position and in the ejection position the ejector rod is arranged in the guide opening.

The ejector rod comprises a detector channel extending through the ejector rod and being fluidically connected with a detector opening at the distal end of the ejector rod such that a test-vacuum may be applied through the detector channel and through the detector opening to detect whether or not a said ophthalmic lens adheres to the convex bearing surface when the ejector rod is arranged in the rest position.

In accordance with a further aspect of the gripper according to the invention, the guide opening is centrally arranged in the convex bearing surface.

Yet in accordance with a further aspect of the gripper according to the invention, the distal end of the ejector has a circular cross-section having an outer diameter between 3 mm and 10 mm, in particular between 4 mm and 7 mm, especially 5 mm.

Still in accordance with a further aspect of the gripper according to the invention, in the ejection position the distal end of the ejector rod protrudes beyond the convex bearing surface by a distance of 10 mm to 14 mm, in particular 11 mm to 13 mm, especially 12 mm.

In accordance with yet another aspect of the gripper according to the invention the actuator is a pneumatic actuator.

Yet in accordance with a further aspect of the invention, the pneumatic actuator comprises:
a piston housing having a housing wall defining a chamber,—a piston comprising a piston rod extending through the chamber defined by the housing wall of the piston housing, the piston further comprising a piston drive plate extending radially outwardly from the piston rod and being movably arranged in the chamber defined by the housing wall in a pressure-tight manner,—a pressure supply inlet arranged in the housing wall and fluidically connected to a proximal portion of the chamber located above an upper surface of the piston drive plate, for supplying overpressure to the proximal portion of the chamber,—a piston return spring arranged between a bottom portion of the housing wall and a lower surface of the piston drive plate in a distal portion of the chamber. The gripper is capable of moving the piston drive plate from an initial position in which the piston return spring is relaxed towards the bottom portion of the housing wall by supplying overpressure to the proximal portion of the chamber through the pressure supply inlet, thereby compressing the piston return spring.

The gripper is further capable of returning the drive plate to the initial position by the piston return spring upon terminating the supply of overpressure to the proximal portion of the chamber. The piston further comprises an ejector rod connection portion being arranged distal to the bottom portion of the housing wall, the ejector rod connection portion accommodating a proximal portion of the ejector rod.

Yet in accordance with a further aspect of the invention, the gripper further comprises a gripper housing to which the piston housing of the pneumatic actuator is fixedly mounted and in the interior of which the ejector rod connecting portion of the piston is movably arranged. In this embodiment, the gripper housing further comprises a gripper housing bottom wall with a gripper housing bottom wall opening through which the ejector rod extends into the guide opening of the convex bearing surface of the gripper head. Furthermore, the ejector rod comprises an ejector rod spring-mounting plate being arranged distal to the gripper housing bottom wall and extending radially from the ejector rod, and an ejector rod spring being arranged between the ejector rod spring-mounting plate and the gripper housing bottom wall. Moreover, in this embodiment, the ejector rod connection portion of the piston of the pneumatic actuator comprises a connector housing having a connector housing bottom wall opening through which the ejector rod extends into a portion of the interior of the gripper housing and further through the gripper housing bottom wall opening. Moreover, the ejector rod comprises a proximal end plate extending radially from the ejector rod, the proximal end plate being arranged in the interior of the connector housing and having a radial extension larger than the radial extension of the connector housing bottom wall opening so that the proximal end plate of the ejector rod is accommodated in the interior of the connector housing and is movably retained therein.

Yet in accordance with a further aspect of the invention, the piston return spring has a spring rate higher than the spring rate of the ejector rod spring.

Yet in accordance with a further aspect of the invention, the detector channel is centrally arranged in the ejector rod and the detector opening is centrally arranged at the distal end of the ejector rod.

Yet in accordance with a further aspect of the invention the detector channel comprises a test-vacuum tube fixedly arranged in the ejector rod and extending through the ejector rod, with a distal end of the test-vacuum tube being arranged in the ejector rod in a pressure-tight manner.

The present invention further suggests a process for transporting an ophthalmic lens, in particular a contact lens such as a soft contact lens, from a start location to a destination location using a gripper according to any one of the preceding claims, the process comprising the steps of:
providing a gripper according to any one of the preceding claims,
positioning the bearing surface of the gripper head at a position located at a predetermined pick-up distance above the ophthalmic lens arranged at the start location,
applying suction through the suction openings in the gripper head to suck the ophthalmic lens and make it adhere to the bearing surface,
moving the gripper with the ophthalmic lens adhered to the bearing surface to a position located at a predetermined release distance above the destination location,
terminating applying suction through the suction openings,
removing the ophthalmic lens from the bearing surface by moving the ejector rod with the ophthalmic lens adhered to the distal end of the ejector rod from the rest position into the ejection position by actuating the actuator, thereby bringing the ophthalmic lens into contact with a receiver liquid provided at the destination location,
releasing the ophthalmic lens from the gripper with the aid of adhesive forces acting on the ophthalmic lens through the contact of the ophthalmic lens with the receiver liquid,
returning the ejector rod from the ejection position to the rest position.

Yet in accordance with a further aspect of the invention, the process further comprises the step of applying a test-vacuum through the detector channel and the detector opening while moving the gripper from the start location to the position located at the predetermined release distance above the destination location to detect whether or not a said ophthalmic lens adheres to the convex bearing surface.

Yet in accordance with a further aspect of the invention, the process further comprises the step of moving the gripper from the position located at the predetermined release distance above the destination location back to the position located at the predetermined pick-up distance above the start location while applying a test-vacuum through the detector channel and the detector opening to detect whether or not a said ophthalmic lens adheres to the convex bearing surface.

The gripper according to the invention has a number of advantages. The ejector rod with the detector opening arranged at the distal end thereof allows to detect whether or not an ophthalmic lens adheres to the convex bearing surface of the gripper or has been released therefrom already when the ejector rod is arranged in the rest position and when the ejector rod is arranged in the ejection position, It is thus possible to reliably determine that the ophthalmic lens has been successfully released from the ejector rod while the gripper is still positioned at the destination location (e.g. at the location where the ophthalmic lens is to be placed in the bowl of the packaging shell). No overpressure is needed to release the ophthalmic lens from the gripper, but rather is mechanically released from the bearing surface by moving the ejector rod from the rest position to the ejection position, thus avoiding the disadvantages resulting from the application of overpressure discussed further above. For example, less water may be entrained with the ophthalmic lens as it is placed in the bowl of the packaging shell, no unwanted blowing of storage liquid (e.g. saline) out of the bowl of the packaging shell may occur, no blowing of the lens out of the bowl may occur, etc.

Use of the gripper according to the invention is even more advantageous in case a receiver liquid is present at the destination location (e.g. a storage liquid such as small amount of saline that may be present in the bowl of the packaging shell). In such case, at the time the ophthalmic lens comes into contact with the receiver liquid during movement of the ejector rod towards the ejection position, the attractive forces between the front surface of the ophthalmic lens and the receiver liquid are stronger than any possible attractive forces that may possibly continue to exist between the distal end of the ejector rod and the ophthalmic lens. This may further help releasing the ophthalmic lens from the distal end of the ejector rod.

In addition, the presence of a single ejector rod reduces any possible attractive forces between the distal end of the ejector rod and the rear surface of the ophthalmic lens when the ejector rod is in the ejection position, compared to the prior art gripper discussed above. As discussed there, the prior art gripper has a plurality of ejector pins to which the ophthalmic lens may continue to adhere in the ejection position.

A further advantage of the gripper according to the invention is, that the ejector rod is securely guided in the guide opening provided in the bearing surface of the gripper. This means, that the ejector rod is always at least partially arranged in the guide opening. Thus, the ejector rod is prevented from getting stuck during its movement from the rest position to the ejection position. In contrast thereto, in the prior art gripper the suction openings provided in the bearing surface are the same openings through which the plurality ejector pins (rods) of the ejector are moved simultaneously at the time of mechanically releasing the lens from the bearing surface of the gripper by moving the ejector with the ejector pins (rods) to the ejection position. Accordingly, in the rest position of the ejector of the prior art gripper the ejector pins are arranged in the interior of the gripper spaced apart from the suction openings to allow suction to be applied therethrough, while in the ejection position the ejector pins penetrate through these suction openings to protrude from the bearing surface to mechanically release the ophthalmic lens from the bearing surface. Accordingly, in the prior art gripper the ejector pins are not guided in the suction openings which may possibly lead to the ejector pins inadvertently getting stuck.

Due to the ejector rod of the gripper according to the invention being arranged in the guide opening both in the rest position and in the ejection position, the ejector rod is always guided in the guide opening, so that it cannot get blocked during movement from the rest position to the ejection position and vice versa. The guide opening additionally allows for suction to be applied therethrough (i.e. around the ejector rod) like through the other suction openings, so that the guide opening also (partially) acts as a suction opening for making the ophthalmic lens adhere to the convex bearing surface of the gripper The test-vacuum applied through the detector channel and the detector opening and the suction applied through the suction openings to make the lens adhere to the bearing surface of the gripper may be separately applied, while at the same time the ejector rod is axially movable relative to the convex bearing surface of the gripper in order to (mechanically) remove the ophthalmic lens from the convex bearing surface.

It is further advantageous when the guide opening is arranged centrally in the convex bearing surface, since in such case the ejector rod with the detector opening is arranged centrally in the convex bearing surface, too. Therefore, even if the ophthalmic lens to be gripped is not located centrally in the test cell, due to the arrangement of the detector opening in the center of the convex bearing surface of the gripper, the ophthalmic lens will in any event be gripped by the gripper in a manner such that it completely covers the detector opening once it adheres to the convex bearing surface. Consequently, the result of the detection—i.e. applying a detection vacuum through the detector channel and the detector opening—is that the presence of an ophthalmic lens adhering to the convex bearing surface of the gripper is securely detected, even if the ophthalmic lens adheres to the bearing surface slightly decentered. Accordingly, it is possible to securely detect whether or not a contact lens has been gripped and removed from the test cell, and it is possible as well to securely detect at the destination location whether the contact lens has been securely released from the gripper (either when the ejector rod is still in the ejection position, or thereafter). Another advantage of the centrally arranged guide is that with the centrally arranged ejector rod guided therein a force is centrally applied by the ejector rod to the ophthalmic lens. This prevents the ophthalmic lens from being tilted during its release from the convex bearing surface and from possibly not being completely released from the convex bearing surface.

The distal end of the ejector may have a circular cross-section generally having an outer diameter that is between 3 mm and 10 mm, in particular between 4 mm and 7 mm, and in particular the outer diameter may be 5 mm, so that the distal end of the convex ejector rod has an outer diameter that is in any event considerably smaller than the diameter of the ophthalmic lens. At the time the ophthalmic lens is placed in the bowl of a packaging shell comprising a receiver liquid (e.g. saline), the ejector rod is moved to the ejection position and therefore, thus releasing the ophthalmic lens from the convex bearing surface of the gripper so that it may only continue to adhere to the distal end of the ejector rod. The contact area of the front surface of the ophthalmic lens to the receiver liquid (e.g. saline) in the packaging shell is in any event larger than the contact area between the rear surface of the ophthalmic lens and the distal end of the ejector rod. Therefore, the attractive forces between the front surface of the ophthalmic lens and the receiver liquid (e.g. saline) are stronger than any possible attractive forces between the rear surface of the ophthalmic lens and the distal end of the ejector rod. The contact lens is thus safely released from the distal end of the ejector rod of the gripper and placed in the bowl of the packaging shell.

Having the ejector rod protrude beyond the convex bearing surface by a distance of 10 mm to 14 mm, 11 mm to 13 mm, and especially 12 mm when the ejector rod is in the ejection position makes sure the ophthalmic lens is spaced from the convex bearing surface of the gripper by a sufficient distance such that no attractive forces act between the convex bearing surface of the gripper and the rear surface of the ophthalmic lens anymore. Hence, it allows for a reliable release of the ophthalmic lens from the gripper.

According to a further advantageous constructional aspect, the actuator is a pneumatic actuator. Pneumatic actuators are known in the production of ophthalmic lenses for their reliability and simplicity.

Such pneumatic actuator may comprise a piston housing, a piston, a pressure supply inlet and a piston return spring as the main components, each with the respective sub-components. An actuator comprising one pressure supply inlet for moving the piston in one direction through the supply of pressure, and a piston return spring for moving the piston back in the other direction is easy to operate. By either supplying overpressure through the pressure supply inlet or by not supplying any overpressure, the pneumatic actuator can be moved to two positions whereby the ejector rod will be ultimately moved to the ejection position or the rest position. The piston may comprise a piston driving plate which is arranged in a pressure-tight manner in a chamber defined by the housing wall of the piston housing. Pressure-tight in this regard means that the piston driving plate may be moved in the chamber by supplying overpressure to the proximal portion of the chamber through the pressure supply inlet. This causes the piston return spring to be compressed and ultimately results in movement of the ejector rod to the ejection position. Upon termination of the supply of overpressure, the piston return spring relaxes and moves the piston drive plate back which ultimately results in the ejector rod being returned to the rest position again.

As also mentioned above already, the gripper may further comprise a gripper housing to which the piston housing of the pneumatic actuator is fixedly mounted. In the interior of the piston housing the ejector rod connection portion is movably arranged. The gripper housing may comprise a gripper housing bottom wall with a gripper housing bottom wall opening through which the ejector rod extends (down) into the guide opening in the bearing surface of the gripper head. The ejector rod further comprises an ejector rod spring-mounting plate which extends radially from the ejector rod and which is arranged distal to the gripper housing bottom wall. An ejector rod spring is arranged between the ejector rod spring-mounting plate and the gripper housing bottom wall. The ejector rod connection portion of the piston of the pneumatic actuator comprises a connector housing having a connector housing bottom wall opening, and through this connector housing bottom wall opening the ejector rod extends into a portion of the interior of the gripper housing and further (down) through the gripper housing bottom wall opening. The ejector rod comprises a proximal end plate that extends radially from the ejector rod, and this proximal end plate of the ejector rod is movably arranged in the interior of the connector housing (of the piston) and has a radial extension that is larger than the radial extension of the connector housing bottom wall opening, so that the proximal end plate of the ejector rod is retained in the interior of the connector housing (of the piston).

Initially, in the rest position of the ejector rod the piston return spring is relaxed and the ejector rod spring is compressed due to the spring rate of the piston return spring being higher than the spring rate of the ejector rod spring. The ejector rod spring is thus prevented from relaxing. Upon the supply of overpressure to the chamber defined by the housing wall of the piston housing, the piston drive plate is moved towards the bottom of the piston housing whereby the piston return spring arranged in the chamber defined by the housing wall of the piston housing is compressed, too. Upon moving the piston drive plate, the ejector rod connection portion of the piston is moved together with the piston drive plate (as it is rigidly connected thereto). However, since the proximal end plate of the ejector rod is movably arranged in the ejector rod connection portion of the piston, the proximal end plate of the ejector rod is not instantaneously moved together with the ejector rod connection portion. Accordingly, immediately after the piston drive plate is moved to compress the piston return spring (by means of supply of overpressure to the chamber) the ejector rod is still arranged in the rest position. Next, the ejector rod spring relaxes while the piston return spring is still retained in the compressed state by the overpressure applied to the chamber defined by the housing wall of the piston housing. As a consequence, through relaxation of the ejector rod spring the ejector rod is moved from the rest position to the ejection position in which the distal end of the ejector rod protrudes beyond the bearing surface of the gripper. Thus, the ophthalmic lens is released from the bearing surface of the gripper and transferred into the bowl of the packaging shell by the ejector rod moving to the ejection position. This transfer of the ophthalmic lens into the bowl of the packaging shell is further enhanced in case a small amount of receiver liquid/storage liquid (e.g. saline) is contained in the bowl of the packaging shell, as has been explained above. With the ejector rod spring continuing to be in the relaxed state (i.e. with the ejector rod still protruding beyond the bearing surface of the gripper) and the ophthalmic lens being transferred, the whole gripper including the ejector rod is moved away from the ophthalmic lens that stays in the bowl of the packaging shell. Thereafter, the supply of overpressure to the chamber formed by the housing wall of the piston housing is discontinued, whereupon the piston return spring relaxes and pushes the piston drive plate back to its original position (before the supply of overpressure to the chamber). The ejector rod connection portion of the piston moves back together with the piston drive plate and takes the proximal end plate of the ejector rod (and thus the whole ejector rod) along with it, so that the ejector rod is moved back to the rest position in which the ejector spring is compressed again (as the spring rate of the piston return spring is higher than the spring rate of the ejector rod spring).

Preferably, the detector channel may be centrally arranged in the ejector rod and the detector opening being centrally arranged at the distal end of the ejector rod which is a simple solution from a constructional point of view.

In particular, the detector channel may comprise a test-vacuum tube fixedly arranged in the ejector rod and extending through the ejector rod (preferably down to the detector opening), and a distal end of the test-vacuum tube is arranged in the ejector rod in a pressure-tight manner. This allows for a reliable and uncomplicated supply of a test-vacuum to the detector opening and thereby to an ophthalmic lens adhering to the gripper (in case such lens actually adheres to the gripper). Especially, in case the ejector rod comprises several individual components which—when assembled—together form the ejector rod, the interfaces between the individual components of the ejector rod do not need to be sealed against one another in a pressure-tight manner, since the test-vacuum may be supplied from outside the gripper through the test-vacuum tube to the detector opening. The proximal end of the test-vacuum tube may project from the proximal end of the gripper to allow for an easy connection/disconnection of a test-vacuum supply tube.

As already mentioned above, in accordance with the invention the process of transporting an ophthalmic lens with a gripper as mentioned above has several advantages. With the ejector rod, the ophthalmic lens may be reliably removed from the convex bearing surface of the gripper and be transferred to a packaging shell containing at least a small amount of a receiver liquid/storage liquid (e.g. saline). Since only one single ejector rod is involved in this process, the amount of water which may be unintentionally entrained to the receiver liquid/storage liquid contained in the bowl is reduced. Since no over-pressure needs to be applied through the suction openings of the gripper to release the ophthalmic lens from the bearing surface, there is no risk of blowing the receiver liquid/storage liquid out of the bowl or even blowing the lens out of the bowl. In essence, the process according to the invention has the same advantages as the gripper, as has been discussed above.

When a test-vacuum is applied through the detector channel and the detector opening while the gripper is moved from the start location to the position located at the predetermined release distance above the destination location, it is possible to detect whether or not said ophthalmic lens actually adheres to the convex bearing surface of the gripper. In case no ophthalmic lens is adhered to the convex bearing surface, no lens may be placed in the bowl of the shell waiting at the transfer station of the primary packaging line during this (attempted) lens transfer, and another ophthalmic lens must be placed in the bowl instead (e.g. by the same gripper during the subsequent lens transfer). Hence, this process step avoids that the bowl of any of the packaging shells remains empty (i.e. does not contain an ophthalmic lens) so that a predetermined number of packaging shells is only forwarded to the sealing station for getting sealed by a foil strip once an ophthalmic lens has been placed into the bowl of each packaging shell.

The process may further comprise the step of moving the gripper from the position located at the predetermined release distance above the destination location back to the position located at the predetermined pick-up distance above the start location, and during this movement a test-vacuum may be applied through the detector channel and the detector opening as well in order to detect whether or not a said ophthalmic lens inadvertently still adheres to the convex bearing surface. It is thus possible to detect whether the ophthalmic lens has been successfully released to the bowl of the packaging shell (in case during an ophthalmic lens has adhered to the gripper during the way of the gripper to the position located at the predetermined pick-up distance where the next ophthalmic lens is provided for getting transferred). In such instance, at least that gripper to which an ophthalmic lens continues to adhere to the bearing surface during the way of the gripper back to the position located at the predetermined pick-up distance above the start location must be cleaned by suitable measures (e.g. the lens still adhering to the bearing surface must be sucked off the bearing surface and must then be discarded), so that during the next lens transfer only one ophthalmic lens (that one provided at the start location for getting transferred during the next lens transfer) adheres to the bearing surface of the gripper.

### BRIEF DESCRIPTION OF THE DRAWINGS

Further advantageous aspects of the invention become apparent from the following description of exemplary embodiments of the invention with the aid of the (schematic) drawings, which are not so scale, in which:

FIG. 1 shows a longitudinal section of a gripper according to the invention, with an ophthalmic lens adhered to the bearing surface, and with the ejector rod in the rest position;

FIG. 2 shows a longitudinal section of the gripper of FIG. 1, the gripper being arranged at a predetermined distance above a destination location where the ophthalmic lens is to be placed, with the ejector rod still in the rest position.

FIG. 3 shows a longitudinal section of the gripper of FIG. 2, with overpressure supplied to the chamber of the piston housing to compress the piston spring, and with the ejector rod spring still in the compressed state;

FIG. 4 shows a longitudinal section of the gripper of FIG. 3, with overpressure still applied to the chamber of the piston housing to keep the piston spring compressed, and with the ejector rod spring in an intermediate state between a compressed state and a relaxed state;

FIG. 5 shows a longitudinal section of the gripper of FIG. 4, with the ejector rod spring being relaxed, and with the ejector rod arranged the ejection position;

FIG. 6 shows a longitudinal section of the gripper of FIG. 5 vertically moved away from the ophthalmic lens after being transferred, with overpressure still applied to the chamber of the piston housing to compress the piston spring, and with the ejector rod spring still in the relaxed state and the ejector rod still arranged in the ejection position; and

FIG. 7 shows a longitudinal section of the gripper of FIG. 6, with overpressure no longer supplied to the chamber of the piston housing, and with the piston spring in the relaxed state, and with the ejector rod spring in the compressed state and the ejector rod arranged in the rest position again.

### DETAILED DESCRIPTION

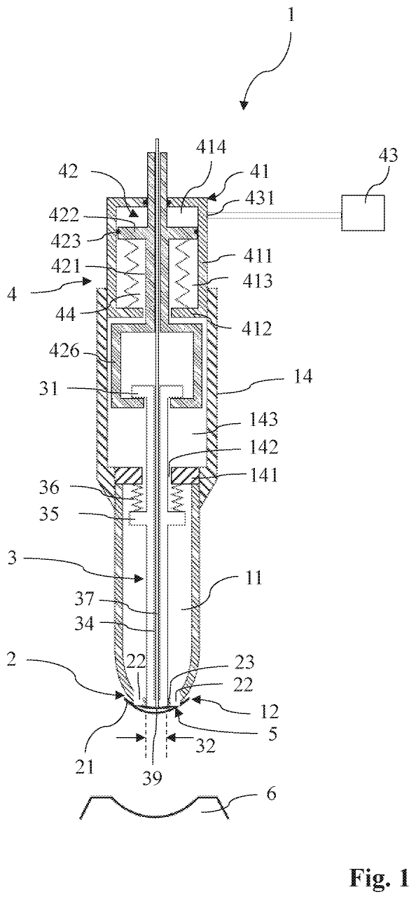

In FIG. 1-FIG. 7 an embodiment of the gripper 1 according to the invention is shown in different operational states. Even though the same embodiment of the gripper 1 is shown in each of the drawings, not all of the reference signs are shown in each of the drawings for the sake of simplicity.

Generally, the gripper 1 comprises a gripper head 2, an ejector rod 3 and an actuator 4 embodied as a pneumatic actuator. The gripper 1 is arranged vertically above a receptacle 6, such as e.g. the bowl of a packaging shell of a primary package. An ophthalmic lens 5, for example a contact lens such as a soft contact lens, is shown in FIG. 1 adhered to the gripper 1) and is to be released from the gripper into the receptacle 6.

As can be seen in FIG. 1, gripper 1 comprises a gripper head 2 which is arranged at the distal end 12 of the gripper 1, and has a convex bearing surface 21 with suction openings 22 provided therein so that suction applied through an interior 11 of gripper 1 makes the ophthalmic lens 5 adhere to the convex bearing surface 21. In addition, a guide opening 23 is centrally arranged in the convex bearing surface 21. A distal end of ejector rod 3 has a circular cross-section having an outer diameter 32 (e.g. 5 mm) and is arranged in the guide opening 23, so that guide opening 23 guides the ejector rod 3 during movement thereof. The guide opening 23 may (partially) act as an additional suction opening (similar to the other suction openings 22) to assist in making the ophthalmic lens 5 adhere to the convex bearing surface 21 of the gripper head 2.

Gripper 1 further has a gripper housing 14 comprising a gripper housing bottom wall 141 with a gripper housing bottom wall opening 142, and an interior 143 of gripper housing.

Ejector rod 3 comprises a detector channel 34 which extends through the ejector rod 3, and which is fluidically connected with a detector opening 39 arranged at the distal end of the ejector rod 3 such that a test-vacuum may be applied through the detector channel 34 and through the detector opening 39 to detect whether or not a said ophthalmic lens 5 adheres to the convex bearing surface 21 when the ejector rod 3 is arranged in the rest position shown in FIG. 1. Detector channel 34 may comprise a test-vacuum tube 37 fixedly arranged in the ejector rod 3 in a pressure-tight manner to allow for an easy and reliably supply of the test-vacuum to the detector opening 39. Ejector rod 3 further comprises an ejector rod spring-mounting plate 35, and an ejector rod spring 36 arranged between the ejector rod spring-mounting plate 35 and the gripper housing bottom wall 141 of gripper housing 14. Ejector rod 3 further comprises a proximal end plate 31.

Pneumatic actuator 4 has a piston housing 41 comprising a comprising a housing wall 411 with a bottom portion 412. Piston housing 4 is fixedly mounted to gripper housing 14. Piston housing 41 defines a chamber 413 (interior of piston housing 41). Pneumatic actuator 4 further comprises a piston 42 that has a piston rod 421 extending through the chamber 413. Piston 42 further comprises a piston drive plate 422 that extends radially outwardly from the piston rod 421 and is movably arranged in the chamber 413. Piston drive plate 422 is provided with a seal 423. Pneumatic actuator 4 further comprises a piston return spring 44 that is arranged between the piston drive plate 422 and the bottom portion 412 of the housing wall 411 of piston housing 41. In addition, pneumatic actuator 4 comprises a pressure supply inlet 431 which is fluidically connected to a proximal portion 414 of the chamber 413, as well as to a pressure supply 43. Piston 42 further comprises an ejector rod connection portion 426 in which the proximal end plate 37 of ejector rod 3 is movably arranged.

In FIG. 1, the ophthalmic lens 5 adheres to the bearing surface 21, and the piston return spring 44 is in the relaxed state. No overpressure is supplied by the pressure supply 43 to the proximal portion 414 of the chamber 413. As the spring rate of piston return spring 44 is higher than the spring rate of ejector rod spring 43, the ejector rod spring 43 is compressed and ejector rod 3 is retained in the rest position.

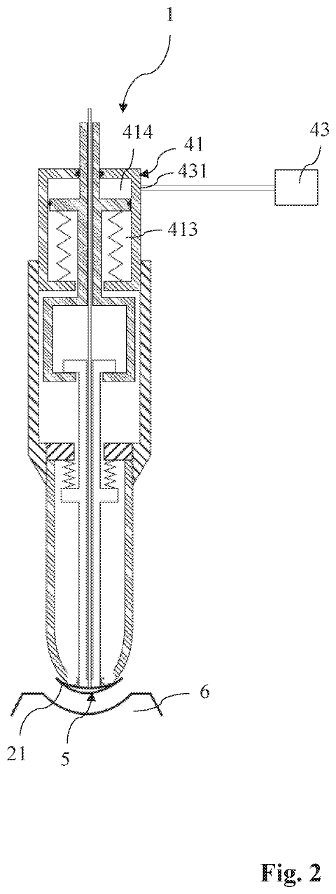

In FIG. 2, the gripper 1 with the ophthalmic lens 5 adhered to its bearing surface 21 is shown in a position in which it is arranged at a predetermined distance to a destination location, which is the receptacle 6. Otherwise, there are no changes vis-à-vis FIG. 1. No overpressure is supplied yet from the pressure supply 43 through the pressure supply inlet 431 into the proximal portion 414 of chamber 413.

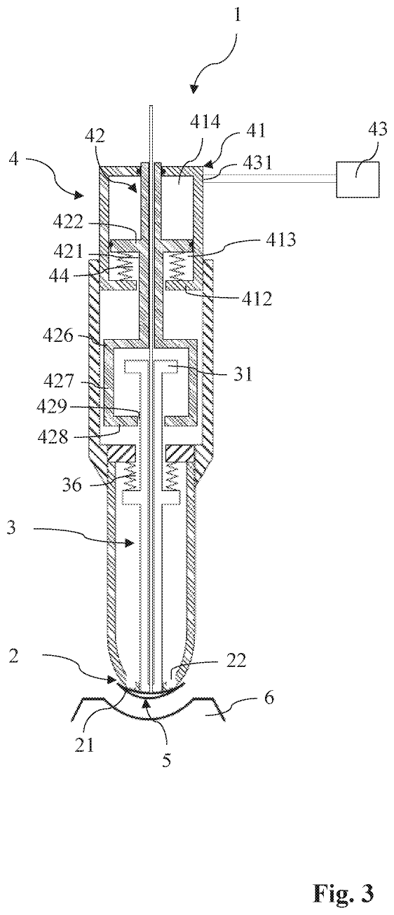

In FIG. 3, the supply of suction through suction openings 22 is discontinued and overpressure is supplied from pressure supply 43 through pressure supply inlet 431 to the proximal portion 414 of chamber 413. As a consequence, piston drive plate 422 is moved towards bottom portion 412 of piston housing 41. Together with piston drive plate 422, the whole piston 42 including piston rod 421 and ejector rod connection portion 426 is moved downwards, and piston return spring 44 is compressed by piston drive plate 422. Ejector rod connection portion 426 comprises a connector housing 427, a connector housing bottom wall 428 and a connector housing bottom wall opening 429 arranged therein. As proximal end plate 31 of ejector rod 3 has a radial extension that is larger than the radial extension of connector housing bottom wall opening 429, ejector rod 3 is (axially) movably retained in the connector housing 427 and may not escape from connector housing 427.

As an immediate consequence of the supply of overpressure to the proximal portion 414 of chamber 413 of piston housing 41, ejector rod connection portion 426 and connector housing 427 are moved downwards. However, since ejector rod 3 is movably retained in connector housing 427, immediately after the supply of overpressure to the proximal portion 414 of chamber 413 ejector rod 3 is not moved but still remains in the rest position, so that ophthalmic lens 5 is not yet released from the bearing surface 21 of gripper head 2.

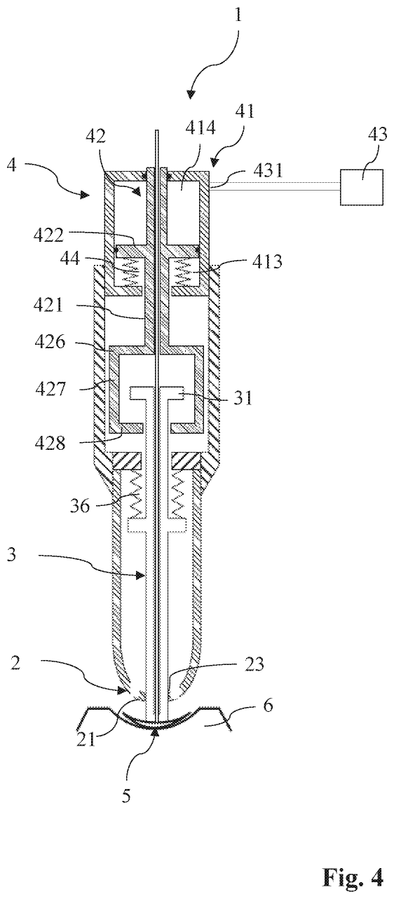

The next action to happen is (with overpressure still being supplied from pressure supply 43 through pressure supply inlet 431 into the proximal portion 414 of chamber 413) that ejector rod spring 36 starts to relax, as shown in FIG. 4. As a consequence of this relaxation of ejector rod spring 36, ejector rod 3 starts to move towards the ejection position, and the distal end of ejector rod 3 is moved through guide opening 23 in the bearing surface 21 of gripper head 2 so that it protrudes beyond the bearing surface 21. Through this movement of ejector rod 3, the ophthalmic lens 5 is (mechanically) released from the bearing surface 21 of gripper head 2 into receptacle 6. In FIG. 4 ejector rod 3 is shown an intermediate position in which it has not fully reached the ejection position (see the proximal end plate 31 of ejector rod 3 that has moved towards bottom wall 428 of connector housing 427 of ejector rod connection portion 426 of piston 42). The spring rate of ejector rod spring 36 is preferably selected such that at the time the ophthalmic lens 5 is placed in the receptacle 6 a certain threshold force acting on the ophthalmic lens 5 may not be exceeded, thus avoiding possible damages to the ophthalmic lens 5.

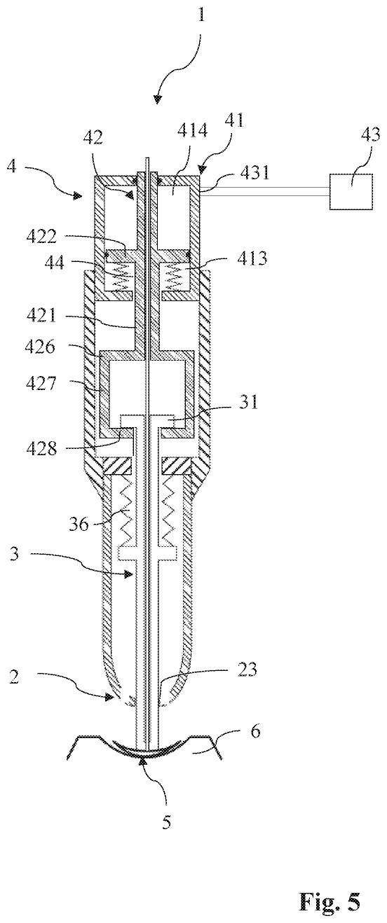

Next, the gripper 1 is retracted (moved upwards) again whereupon the ejector rod spring 36 continues to relax until it has reached the fully relaxed state corresponding to the ejection position of ejector rod 3, this being shown in FIG. 5. In that state, the proximal end plate 31 of ejector rod 3 abuts against connector housing bottom wall 428 of connector housing 427 of the ejector rod connection portion 426 of piston 42.

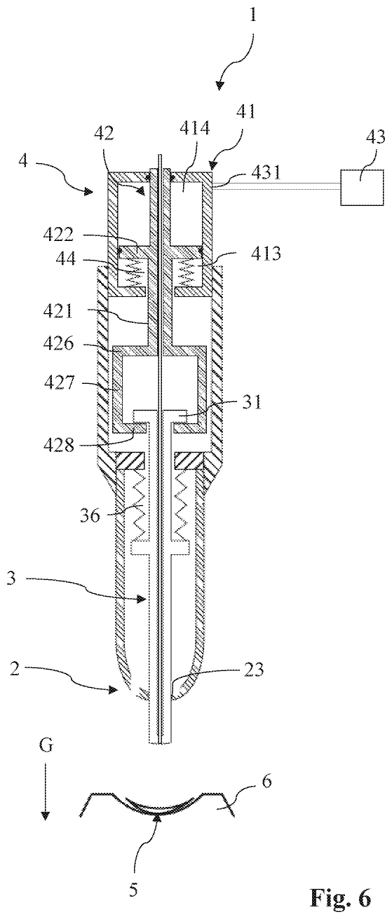

Further retraction (upward movement) of the gripper 1 results in the distal end of ejector rod 3 getting released from the ophthalmic lens 5 arranged in the receptacle 6, as is shown in FIG. 6. As has been mentioned, although not being mandatory it is preferred that a small amount of receiver liquid (e.g. storage liquid such as saline) is contained in the receptacle 6 (not shown in the drawings). Such receiver liquid increases the attractive forces acting on the ophthalmic lens 5 so that the ophthalmic lens 5 may not inadvertently continue adhere to the distal end of the ejector rod 3 as the distal end of the ejector rod is released from the ophthalmic lens (during retraction of the gripper 1). However, in general the attractive forces between the receptacle 6 and the ophthalmic lens 5 together with the gravitational forces G acting on the ophthalmic lens 5 are also sufficient to get the ophthalmic lens 5 released from the distal end of the ejector rod 3.

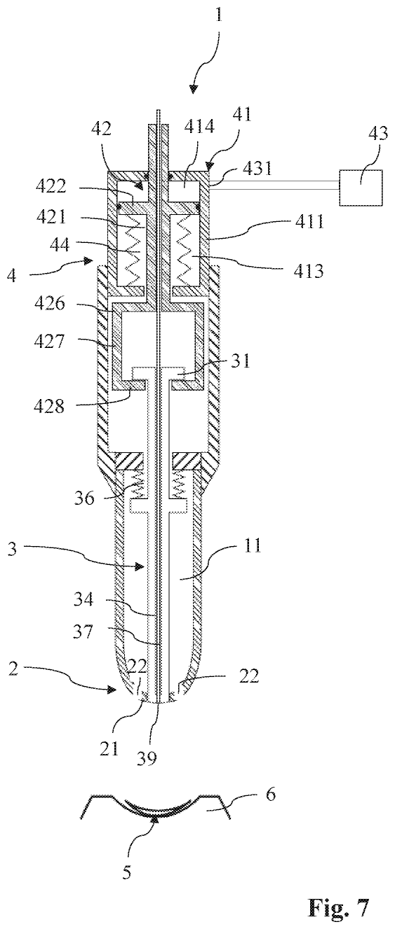

Gripper 1 is then further retracted (moved upwards), and the supply of overpressure from the pressure supply 43 through pressure supply inlet 431 into the proximal portion 414 of chamber 413 of piston housing 41 is terminated. As a consequence of this termination of supply of overpressure the piston spring 44 relaxes, thus moving piston drive plate 422 upwards returning it to its original position. Together with piston drive plate 422 the whole piston 42 including piston rod 421 and ejector rod connection portion 426 with connector housing 427 is moved upwards. As the proximal end plate 31 of ejector rod 3 abuts against connector housing bottom wall 428, ejector rod 3 is returned back to the rest position and ejector rod spring 36 is compressed again. This state of the gripper is shown in FIG. 7. Gripper 1 is now in its initial state in which it may be moved back to the start location to pick up the next ophthalmic lens (through the application of suction to the suction openings 22 through the interior 11 of gripper 1). During the way back to the start location, a test-vacuum may be supplied through the test-vacuum tube 37 of detector channel 34 to detector opening 39 again in order to make sure the ophthalmic lens has been released from the bearing surface 21 of gripper head 2 and does not inadvertently continue to adhere thereto.

An embodiment of the invention has been explained with the aid of the drawings. However, the invention is not limited to this embodiment. Various modifications and changes are possible without departing from the technical teaching of the invention. The scope of protection is therefore defined by the appended claims.

1. Gripper (1) for an ophthalmic lens (5), in particular a contact lens such as a soft contact lens, the gripper comprising:
a gripper head (2) heaving a convex bearing surface (21) for the ophthalmic lens (5) to adhere thereto, wherein the convex bearing surface (21) comprises a plurality of suction openings (22) through which suction supplied to an interior (11) of the gripper can be applied to the ophthalmic lens (5) in order to make the ophthalmic lens (5) adhere to the convex bearing surface (21), wherein the convex bearing surface (21) further comprises a guide opening (23);
an ejector rod (3) movably arranged in the guide opening (23), for mechanically displacing the ophthalmic lens (5) away from the convex bearing surface (21);
an actuator (4) connected to the ejector rod (3), for moving the ejector rod (3) from a rest position in which a distal end of the ejector rod (3) is arranged in the guide opening (23) but does not protrude distally beyond the convex bearing surface (21), to an ejection position in which the distal end of the ejector rod (3) protrudes beyond the convex bearing surface (21),
wherein both in the rest position and in the ejection position the ejector rod (3) is arranged in the guide opening (23),
and wherein the ejector rod (3) comprises a detector channel (34) extending through the ejector rod (3) and being fluidically connected with a detector opening (39) at the distal end of the ejector rod (3) such that a test-vacuum may be applied through the detector channel (34) and through the detector opening (39) to detect whether or not a said ophthalmic lens (5) adheres to the convex bearing surface (21) when the ejector rod (3) is arranged in the rest position.

2. Gripper according to claim 1, wherein the guide opening (23) is centrally arranged in the convex bearing surface (21).

3. Gripper according to claim 1, wherein the distal end of the ejector rod (3) has a circular cross-section having an outer diameter between 3 mm and 10 mm, in particular between 4 mm and 7 mm, especially 5 mm.

4. Gripper according to claim 1, wherein in the ejection position the distal end of the ejector rod (3) protrudes beyond the convex bearing surface (21) by a distance of 10 mm to 14 mm, in particular 11 mm to 13 mm, especially 12 mm.

5. Gripper according to claim 1, wherein the actuator (4) is a pneumatic actuator.

6. Gripper according to claim 5, wherein the pneumatic actuator (4) comprises
a piston housing (41) having a housing wall (411) defining a chamber (413),
a piston (42) comprising a piston rod (421) extending through the chamber (413) defined by the housing wall (411) of the piston housing (41), the piston (42) further comprising a piston drive plate (422) extending radially outwardly from the piston rod (421) and being movably arranged in the chamber (413) defined by the housing wall (411) in a pressure-tight manner,
a pressure supply inlet (431) arranged in the housing wall (411) and fluidically connected to a proximal portion (414) of the chamber (413) located above an upper surface of the piston drive plate (422), for supplying overpressure to the proximal portion (414) of the chamber (413),
a piston return spring (44) arranged between a bottom portion (412) of the housing wall (411) and a lower surface of the piston drive plate (422) in a distal portion (414) of the chamber (413),
so as to be capable of moving the piston drive plate (422) from an initial position in which the piston return spring (44) is relaxed towards the bottom portion (412) of the housing wall (411) by supplying overpressure to the proximal portion (414) of the chamber (413) through the pressure supply inlet (431), thereby compressing the piston return spring (44), and so as to be capable of returning the piston drive plate (422) to the initial position by the piston return spring (44) upon terminating the supply of overpressure to the proximal portion (414) of the chamber (413),
wherein the piston (42) further comprises an ejector rod connection portion (426) arranged distal to the bottom portion (412) of the housing wall (411), the ejector rod connection portion (426) accommodating a proximal portion of the ejector rod (3).

7. Gripper according to claim 6,
wherein the gripper further comprises a gripper housing (14) to which the piston housing (41) of the pneumatic actuator (4) is fixedly mounted and in the interior of which the ejector rod connecting portion (426) of the piston (42) is movably arranged;
wherein the gripper housing (14) further comprises a gripper housing bottom wall (141) with a gripper housing bottom wall opening (142) through which the ejector rod (3) extends into the guide opening (23) of the convex bearing surface (21) of the gripper head (2);
wherein the ejector rod (3) comprises an ejector rod spring-mounting plate (35) arranged distal to the gripper housing bottom wall (142) and extending radially from the ejector rod (3), and an ejector rod spring (36) arranged between the ejector rod spring-mounting plate (35) and the gripper housing bottom wall (141);
wherein further the ejector rod connection portion (426) of the piston (42) of the pneumatic actuator (4) comprises a connector housing (427) having a connector housing bottom wall opening (429) through which the ejector rod (3) extends into a portion of the interior of the gripper housing (14) and further through the gripper housing bottom wall opening (142),
and wherein the ejector rod (3) comprises a proximal end plate (31) extending radially from the ejector rod (3), the proximal end late (31) being arranged in the interior of the connector housing (426) and having a radial extension larger than the radial extension of the connector housing bottom wall opening (429) so that the proximal end plate (31) of the ejector rod (3) is accommodated in the interior of the connector housing (427) and is movably retained therein.

8. Gripper according to claim 7, wherein the piston return spring (44) has a spring rate higher than the spring rate of the ejector rod spring (36).

9. Gripper according to claim 1, wherein the detector channel (34) is centrally arranged in the ejector rod (3) and the detector opening (39) is centrally arranged at the distal end of the ejector rod (3).

10. Gripper according to claim 9, wherein the detector channel (34) comprises a test-vacuum tube (37) fixedly arranged in the ejector rod (3) and extending through the ejector rod (3), with a distal end of the test-vacuum tube (37) being arranged in the ejector rod (3) in a pressure-tight manner.

11. Process for transporting an ophthalmic lens (5), in particular a contact lens such as a soft contact lens, from a start location to a destination location using a gripper (1) according to claim 1, the process comprising the steps of:
providing the gripper (1),
positioning the bearing surface (21) of the gripper head (2) at a position located at a predetermined pick-up distance above the ophthalmic lens (5) arranged at the start location,
applying suction through the suction openings (22) in the gripper head (2) to suck the ophthalmic lens (5) and make it adhere to the bearing surface (21),
moving the gripper (1) with the ophthalmic lens (5) adhered to the bearing surface (21) to a position located at a predetermined release distance above the destination location,
terminating applying suction through the suction openings (22),
removing the ophthalmic lens (5) from the bearing surface (21) by moving the ejector rod (3) with the ophthalmic lens (5) adhered to the distal end of the ejector rod (3) from the rest position into the ejection position by actuating the actuator (4), thereby bringing the ophthalmic lens (5) into contact with a receiver liquid provided at the destination location,
releasing the ophthalmic lens (5) from the gripper (1) with the aid of adhesive forces acting on the ophthalmic lens (5) through the contact of the ophthalmic lens (5) with the receiver liquid,
returning the ejector rod (3) from the ejection position to the rest position.

12. Process according to claim 11, further comprising the step of:
applying a test-vacuum through the detector channel (34) and the detector opening (39) while moving the gripper (1) from the start location to the position located at the predetermined release distance above the destination location to detect whether or not a said ophthalmic lens (5) adheres to the convex bearing surface (21).

13. Process according to claim 11, further comprising the step of:
moving the gripper (1) from the position located at the predetermined release distance above the destination location back to the position located at the predetermined pick-up distance above the start location while applying a test-vacuum through the detector channel (34) and the detector opening (39) to detect whether or not a said ophthalmic lens (5) adheres to the convex bearing surface (21).
